(19) United States
(12) Patent Application Publication
(10) Pub. No.: US 2015/0329418 A1
(43) Pub. Date: Nov. 19, 2015

(54) REINFORCED GLASS SUBSTRATE AND METHOD FOR PRODUCING SAME

(71) Applicant: Nippon Electric Glass Co., Ltd., Shiga (JP)

(72) Inventors: Takashi MURATA, Shiga (JP); Kosuke KAWAMOTO, Shiga (JP)

(21) Appl. No.: 14/651,386

(22) PCT Filed: Mar. 10, 2014
(86) PCT No.: PCT/JP2014/056116

§ 371 Date: Jun. 11, 2015

(30) Foreign Application Priority Data
Mar. 25, 2013 (JP) 2013-061355

(51) Int. Cl. C03C 21/00; C03C 4/18; C03C 3/097; C03C 17/02; C03C 3/091

(52) U.S. Cl. CPC C03C 21/002; C03C 17/02; C03C 3/091; C03C 3/097; C03C 4/18; C03C 2217/213; C03C 2218/154; C03C 2218/32; C03C 2204/00

(57) ABSTRACT

The present invention provides a tempered glass substrate capable of achieving both higher strength and a smaller thickness. The tempered glass substrate of the present invention has a compressive stress layer, the tempered glass substrate having a thickness of 1.5 mm or less, and a depth of layer in an end surface larger than a depth of layer in a main surface.

### TECHNICAL FIELD

The present invention relates to a tempered glass substrate and a method of manufacturing the same, and more specifically, to a tempered glass substrate suitable for, for example, a cellular phone, a digital camera, a personal digital assistant (PDA), or a touch panel display, and a method of manufacturing the same.

### BACKGROUND ART

Devices such as a cellular phone, a digital camera, a PDA, and a touch panel display tend to foe more widely used. A glass substrate to be used for such applications has been required to have a small thickness and a light weight, as well as high mechanical strength. In such circumstance, some of the devices use a glass substrate subjected to chemical tempering treatment such as ion exchange treatment, i.e. a tempered glass substrate (see Patent Literature 1 and Non Patent Literature 1).

### CITATION LIST

### Patent Literature

Patent Literature 1: JP 2006-83045 A

### Non Patent Literature

Non-Patent Literature 1: Tetsuro Izumitani et al., “New glass and physical properties thereof,” First edition, Management System Laboratory. Co., Ltd., Aug. 20, 1984, p. 451-498

### SUMMARY OF INVENTION

### 1. Technical Problem

In recent years, the tempered glass substrate has increasingly been required to have higher strength and a smaller thickness.

However, it is difficult to achieve both the higher strength and the smaller thickness. The mechanical strength of the tempered glass substrate is effectively increased by increasing the compressive stress value and depth of layer of a compressive stress layer. However, when the compressive stress value and depth of layer of the compressive stress layer are increased, a tensile stress corresponding to the magnitude of the compressive stress is generated in an internal portion of the tempered glass substrate, resulting in a risk of the tempered glass substrate breaking. Such tendency is more remarkable particularly when the tempered glass substrate has a smaller thickness.

The internal tensile stress is represented by the following relational equation: internal tensile stress value [MPa]″′(compressive stress value in main surface [MPa]×depth of layer in main surface [μm])/(substrate thickness [μm]−depth of layer in main surface [μm]×2) . As is apparent from the relational equation, the tempered glass substrate has a risk of self-destruction owing to the internal tensile stress. In particular, the tempered glass substrate having a smaller thickness has a higher risk of self-destruction when the compressive stress value and depth of layer in a main surface are increased. In consequence, it is difficult for the tempered glass substrate having a smaller thickness to achieve higher strength.

The present invention has been made in view of the above-mentioned circumstances, and a technical object of the present invention is to devise a tempered glass substrate capable of achieving both higher strength and a smaller thickness, and a method of manufacturing the same.

### 2. Solution to Problem

In order to achieve both higher strength and a smaller thickness in a tempered glass substrate, the inventors of the present invention have diligently studied distribution of compressive stress-strain generated in an internal portion of the tempered glass substrate. As a result, the inventors have found that the tempered glass substrate has a high risk of breaking from an end surface thereof, and in this case, the main surface of the tempered glass substrate has in-plane strength higher than the strength of the end surface. The inventors have further found that the end surface of the tempered glass substrate has or is liable to have a deep flaw leading to breakage, but the main surface hardly has a deep flaw.

Based on the above-mentioned findings, the inventors of the present invention have found that the tempered glass substrate can achieve both higher strength and a smaller thickness when the tempered glass substrate has stress distribution different between a main surface direction and an end surface direction while the internal tensile stress of the tempered glass substrate is appropriately controlled. Thus, the finding is proposed as the present invention. That is, a tempered glass substrate of the presets t invention has a compressive stress layer, the tempered glass substrate having a thickness of 1.5 mm or less, and a depth of layer in an end surface larger than a depth of layer in a main surface. Herein, the “main surface” corresponds to a surface of the tempered glass substrate in a thickness direction (front surface and back surface), and generally refers to an effective surface (for example, a display surface and a back surface corresponding to the display surface in the case of a display application). The “end surface” corresponds to a surface other than the main surface, and generally refers to a side surface forming an outer peripheral portion of the tempered glass substrate. The “compressive stress value” and the “depth of layer” may be calculated on the basis of observation of the number of interference fringes and each interval between the interference fringes with a surface stress meter.

Second, it is preferred that in the tempered glass substrate of the present invention, the main surface be unpolished. When the main surface of the tempered glass substrate is polished, the depth of layer in the end surface can be made larger than the depth of layer in the main surface. However, in such method, a flaw is generated on the main surface, and hence it becomes difficult to maintain the mechanical strength of the tempered glass substrate. In other words, when the main surface is unpolished, the mechanical strength of the tempered glass substrate is easily maintained, and the manufacturing efficiency of the tempered glass substrate can be enhanced.

Third, it is preferred that in the tempered glass substrate of the present invention, the main surface be prevented from being etched. With this, the manufacturing efficiency of the tempered glass substrate can be enhanced.

Fourth, it is preferred that the tempered glass substrate of the present invention comprise a film on the main surface. With this, the compressive stress value and depth of layer in the main surface are easily controlled. Further, the film can be effectively utilized as a functional film such as a conductive film or an antireflection film.

Fifth, it is preferred that in the tempered glass substrate of the present invention, the film have a thickness of from 5 to 1,000 nm.

Sixth, it is preferred that the tempered glass substrate of the present invention contain as a component of the film any one of SiO₂, Nb₂O₅, TiO₂, and ITO (tin-doped indium oxide).

Seventh, it is preferred that the tempered glass substrate of the present invention have an internal tensile stress value of 200 MPa or less.

Eighth, it is preferred that the tempered glass substrate of the present invention comprise as a glass composition, in terms of mass %, 45 to 75% of SiO₂, 1 to 30% of Al₂O₃, 0 to 20% of Na₂O, and 0 to 20% of K₂O.

Ninth, it is preferred that the tempered glass substrate of the present invention have a compressive stress value and depth of layer in the main surface of 50 MPa or more and 100 μm or less, respectively, and a compressive stress value and depth of layer in the end surface of 300 MPa or more and 10 μm or more, respectively.

Tenth, it is preferred that the tempered glass substrate of the present invention have a density of 2.6 g/cm³ or less. Herein, “Young's modulus” refers to a value measured by a bending resonance method.

Eleventh, it is preferred that the tempered glass substrate of the present invention have a Young's modulus of 67 GPa or more. Herein, “Young's modulus” refers to a value measured by a bending resonance method.

Twelfth, it is preferred that the tempered glass substrate of the present invention be used for a display.

Thirteenth, it is preferred that the tempered glass substrate of the present invention be used for a touch panel display.

Fourteenth, a method or manufacturing a tempered, glass substrate of the present invention comprises: a step (1) of blending glass raw materials to obtain a glass batch; a step (2) of melting the glass batch, followed by forming the resultant molten glass into a glass substrate having a thickness of 1.5 mm or less; a step (3) of forming a film on a main surface of the glass substrate; and a step (4) of subjecting the glass substrate comprising the film to ion exchange treatment to form compressive stress layers in the main surface and an end surface of the glass substrate, to thereby obtain a tempered glass substrate.

### DESCRIPTION OF EMBODIMENTS

A tempered glass substrate of the present invention has a thickness of 1.5. mm or less, preferably 1.3 mm or less, 1.1 mm or less, 1.0 mm or less, 0.8 mm or less, 0.7 mm or less, 0.6 mm or less, 0.5 mm or less, 0.4 mm or less, 0.3 mm or less, or 0.2 mm or less, particularly preferably 0.1 mm or less. As the tempered glass substrate has a smaller thickness, the tempered glass substrate can achieve a lighter weight. As a result, a device having a smaller thickness and a lighter weight can be realized.

When a depth of layer in a main surface is too large, the tempered glass substrate has a risk of self-destruction owing to an excessively large internal tensile stress. On the other hand, when the depth of layer in the main surface is too small, the tempered glass substrate is liable to break from a polishing scar, a handling flaw, or the like. Therefore, it is necessary to regulate the depth of layer in the main surface in consideration of the balance between the substrate thickness and mechanical strength.

When the depth of layer in the main surface is defined as DT and a depth of layer in an end surface is defined as DH, the tempered glass substrate of the present invention has a DT/DH value of preferably from 0.1 to 0.93, from 0.1 to 0.7, from 0.1 to 0.5, from 0.1 to 0.45, or from 0.15 to 0.45, particularly preferably from 0.2 to 0.4. When the DT/DH value fails within the above-mentioned range, the depth of layer in the end surface is appropriately controlled, and hence the mechanical strength of the tempered glass substrate can be increased without disadvantageously increasing the internal tensile stress.

In the case where the substrate thickness is 0.5 mm or less, the depth of layer in the main surface is preferably 50 μm or less, 45 μm or less, 35 μm or less, 30 μm or less, 25 μm or less, 20 μm or less, or 15 μm or less, particularly preferably 10 μm or less. In contrast, in the case where the substrate thickness is more than 0.5 mm, the upper limit range of the depth of layer in the main surface is preferably 100 μm or less, 80 μm or less, 60 μm or less, 50 μm or less, or 45 μm or less, particularly preferably 35 μm or less. The lower limit range thereof is preferably 5 μm or more, 10 μm or more, 15 μm or more, 20 μm or more, or 25 μm or more, particularly preferably 30 μm or more.

The depth of layer in the end surface is preferably 10 μm or more, 15 μm or more, 20 μm or more, 25 μm or more, 30 μm or more, 35 μm or more, 40 μm or more, 45 μm or more, 50 μm or more, or 55 μm or more, particularly preferably 60 μm or more. A deep flaw is liable to be generated on the end surface at the time of handling in manufacturing steps or processing (chamfering processing) of the end surface. When the depth of layer in the end surface is less than 10 μm, the tempered glass substrate is liable to break from such flaw, and hence if becomes difficult to increase the mechanical strength.

A compressive stress value in the main surface is preferably 50 MPa or more, 100 MPa or more, 200 MPa or more, 300 MPa or more, or 400 MPa or more, particularly preferably 500 MPa or more. As the compressive stress value in the main surface becomes higher, the mechanical strength of the tempered glass substrate becomes higher. It should be noted that the upper limit of the compressive stress value in the main surface is preferably 900 MPa, particularly preferably 800 MPa. With this, a disadvantageous increase in the internal tensile stress is easily avoided.

A compressive stress value in the end surface is preferably 300 MPs or more, 400 MPa or more, 500 MPa or more, 600 MPa or sore, 700 MPa or more, 800 MPa or more, or 900 MPa or more, particularly preferably 1,000 MPa or more. As the compressive stress value in the end surface becomes higher, the mechanical strength of the tempered glass substrate becomes higher.

The tempered glass substrate of the present, invention preferably comprises a film on the main surface. With this, the compressive stress value and depth of layer in the main surface can be controlled. For example, the film is formed on the main surface of a glass substrate, and then the glass substrate comprising the film is subjected to ion exchange treatment to form compressive stress layers in the main surface and end surface of the glass substrate. Thus, the depth of layer in the end surface can be made larger than the depth of layer in the main surface. It should be noted that, in the case where warpage of the tempered glass substrate is permitted (or in the case where a curved shape is to be positively imparted to the tempered glass substrate), the film may be formed on only one of the main surfaces. In the case where the warpage of the tempered glass substrate is to be reduced as much as possible, the film is preferably formed on all the main surfaces (both surfaces).

The tempered glass substrate of the present invention preferably contains as a component of the film any one of SiO₂, Nb₂O₅, TiO₂, and ITO, particularly preferably contains SiO₂. The film is not limited to a single-layer film, and may foe a multi-layer film. Further, the film is preferably designed so as to function also as a conductive film, an antireflection film, or the like.

The lower limit of the film thickness is preferably 5 nm or more, 10 nm or more, 20 nm or more, 30 nm or more, 50 nm or more, or 80 nm or more, particularly preferably 100 nm or more. The upper limit of the film thickness is preferably 1,000 nm or less, 800 nm or less, or 600 nm or less, particularly preferably 400 nm or loss. When the film thickness is too small, it becomes difficult to reduce the depth of layer in the main surface. On the other hand, when the film thickness is too large, the formation of the film takes a long time. Besides, the depth of layer in the main surface becomes too small, and hence it becomes difficult to maintain the mechanical strength of the tempered glass substrate.

When the ratio (the compressive stress value in the main surface in the case where the film is formed on all the main surfaces)/(the compressive stress value in the main surface in the case where the film, is not formed) is represented by the R_{C3}, the R_{C3} is preferably 1.2 or less, 1.1 or less, 1.0 or less, 0.9 or less, 0.8 or less, or 0.7 or less, particularly preferably 0.6 or less. In addition, when, the ratio (the depth of layer in the main surface in the case where the film is formed on all the main surfaces)/(the depth of layer in the main surface in the case where the film is not formed) is represented by R_{DOL}, the R_{DOL} is preferably less than 1.0, 0.9 or less, 0.8 or less, 0.7 or less, 0.6 or less, 0.5 or less, or 0.4 or less, particularly preferably 0.3 or less. With this, the internal tensile stress is appropriately reduced with ease.

As a method of forming the film, various methods may be employed. For example, a sputtering method, a CVD method, a dip coating method, or the like may be employed. Of those methods, a sputtering method is preferred from the viewpoint of controlling the film thickness.

It should be noted that, when the film is to be effectively utilized as a functional film, there is no need to separately conduct a step of removing the film after the ion exchange treatment. When the in-plane strength of the main surface is to be increased as much as possible, the step of removing the film may be separately conducted after the ion exchange treatment.

The tempered glass substrate of the present invention preferably comprises as a glass composition, in terms of mass %, 45 to 75% of SiO₂, 1 to 30% of Al₂O₃, 0 to 20% of Na₂O, and 0 to 20% of K₂O. The reasons why the contents of the components are specified as described above are hereinafter described. It should be noted that the expression “%” in the description of the glass composition refers to mass %, unless otherwise stated.

SiO₂ is a component that forms a glass network. The content of SiO₂ is preferably from 45 to 75%, from 50 to 75%, or from 52 to 65%, particularly preferably from 52 to 63%. When the content of SiO₂ is less than 45%, a thermal expansion coefficient becomes too high, and hence thermal shock resistance is liable to lower. Besides, vitrification does not occur easily, and devitrification resistance is liable to lower. On the other hand, when the content of SiO₂ is more than 75%, meltability and formability are liable to lower. Besides, the thermal expansion coefficient becomes too low, and matching of the thermal expansion coefficient with those of peripheral materials becomes difficult.

Al₂O₃ is a component that enhances heat resistance, ion exchange performance, and a Young's modulus. The content of Al₂O₃ is preferably from 1 to 30%. When the content of Al₂O₃ is too small, the ion exchange performance may not be sufficiently exhibited. On the other hand, when the content of Al₂O₃ is too large, acid resistance is liable to lower. Therefore, it is difficult to achieve both the ion exchange performance and the acid resistance by adjusting the content of Al₂O₃. However, when the film is formed on the main surface, the ion exchange performance can be enhanced by increasing the content of Al₂O₃, while the acid resistance is maintained with the film. In consequence, even a tempered glass substrate having a thickness of 0.5 mm or less can achieve a significantly large compressive stress value and a significantly large depth of layer while ensuring the acid resistance. It should be noted that, when the content of Al₂O₃ is more than 30%, a devitrified crystal is liable to be deposited in glass. Besides, the thermal expansion coefficient becomes too low, and matching of the thermal expansion coefficient with those of peripheral materials becomes difficult. In addition, when the content of A₂O₃ is more than 30%, a viscosity at high temperature increases, and the meltability may lower. The upper limit of the range of the content of Al₂O₃ is preferably 25% or less, 23% or less, 22% or less, 21% or less, or 20% or less, and the lower limit thereof is preferably 1.5% or more, 3% or more, 5% or more, 10% or more, 11% or more, 12% or more, 14% or more, 15% or mores, 16.5% or more, 17% or more, or 18% or more.

Na₂O is an ion exchange component, and is also a component that lowers the viscosity at high temperature to enhance the meltability and the formability and improves the devitrification resistance. The content of Na₂O is preferably from 0 to 20%, from 7 to 20%, from 7 to 18%, from 8 to 16%, from 10 to 16%, or from 12 to 16%, particularly preferably from 12 to 15%. When the content of Na₂O is more than 20%, the thermal expansion coefficient becomes too high, and hence, the thermal shock resistance lowers, and matching of the thermal expansion coefficient with those of peripheral materials becomes difficult. Further, when the content of Na₂O is more than 20%, the glass composition loses its component balance, and hence the devitrification resistance tends to lower contrarily. Further, when the content of Na₂O is more than 20%, a strain point becomes too low, and the heat resistance may lower. Besides, the ion exchange performance may lower contrarily.

K₂O has an effect of promoting ion exchange, and has an effect of enlarging the depth of layer, among alkali metal oxides. Further, K₂O is a component that lowers the viscosity at high temperature to enhance the meltability and the formability, reduces a crack generation ratio, and improves the devitrification resistance. The content of K₂O is preferably from 0 to 20%, from 0 to 10%, from 0 to 8%, from 0 to 5%, from 0.1 to 4%, or from 0.1 to 2%, particularly preferably from 0.5 to less than 2%. When the content of K₂O is more than 20%, the thermal expansion coefficient becomes too high, the thermal shock resistance lowers, and matching of the thermal expansion coefficient with those of peripheral materials becomes difficult. Further, when the content of K₂O is more than 20%, the glass composition loses its component balance, and hence the devitrification resistance tends to lower contrarily.

The mass ratio (Al₂O+K₂O)/Na₂O is preferably from 0.1 to 6.5, from 0.1 to 5, from 0.2 to 3, from 0.2 to 2.5, from 0.4 to 2, or from 0.7 to 1.7, particularly preferably from 1.0 to 1.5. With this, the depth of layer can be increased through the ion exchange treatment. When the mass ratio (Al₂O₃+K₂O)/Na₂O is less than 0.1, it becomes difficult to increase the depth of layer. On the other hand, when the mass ratio (Al₂O₃+K₂O)/Na₂O is more than 6.5, the glass composition loses its component balance, and hence the devitrification resistance tends to lower. Besides, the compressive stress value is liable to lower owing to lack of the Na₂O component.

In addition to the components described above, for example, the following components may be added.

B₂O₃ is a component that lowers a liquidus temperature, the viscosity at high temperature, and a density. The content of B₂O₃ is preferably from 0 to 7%, from 0 to 5%, or from 0.1 to 3%, particularly preferably from 0.5 to 1%. When the content of B₂O₃ is more than 7%, weathering occurs on the main surface by the ion exchange treatment, water resistance lowers, and viscosity at low temperature lowers, with the result that the compressive stress value and the depth of layer lower in some cases.

Li₂O is an ion exchange component, and is also a component that lowers the viscosity at high temperature to enhance the meltability and the formability. Further, Li₂O is a component that enhances the Young's modulus. The content of Li₂O is preferably from 0 to 20%, from 0 to 10%, from 0 to 8%, from 0 to 6%, from 0 to 4%, from 0 to 3.5%, from 0 to 3%, from 0 to 2%, or from 0 to 1%, particularly preferably from 0 to 0.1%. When the content of Li₂O is more than 20%, the glass is liable to be devitrified, and a liquidus viscosity is liable to lower. Further, the thermal, expansion coefficient becomes too high, and hence, the thermal shock resistance lowers, and matching of the thermal expansion coefficient with those of peripheral materials becomes difficult. In addition, when the content of Li₂O is more than 20%, the strain point becomes too low, and hence the heat resistance may lower. Besides, the ion exchange performance may lower contrarily. It should be noted that, in the case of introducing Li₂O, its content is preferably 0.001% or more, particularly preferably 0.01% or more.

When the content of Li₂O+Na₂O+K₂O (the total content of Li₂O, Na₂O, and K₂O) is too small, the ion exchange performance and the meltability are liable to lower. Therefore, the content of Li₂O+Na₂O+K₂O is preferably 5% or more, 10% or more, 13% or more, or 15% or more, particularly preferably 17% or more. On the other hand, when the content of Li₂O+Na₂O+K₂O is too large, the glass is liable to be devitrified. In addition, the thermal expansion coefficient becomes too high, and hence, the thermal shock resistance lowers, and matching of the thermal expansion coefficient with those of peripheral materials becomes difficult. In addition, when the content of Li₂O+Na₂O+K₂O is too large, the strain point becomes too low, and the compressive stress value may excessively lower. Accordingly, the content of Li₂O+Na₂O+K₂O is preferably 30% or less, or 22% or less, particularly preferably 20% or less.

MgO is a component that lowers the viscosity at high temperature to enhance the meltability, the formability, the strain point, and the Young's modulus. In addition, MgO shows a relatively high effect of enhancing the ion exchange performance among alkaline earth metal oxides. However, when the content of MgO is too large, the density, the thermal expansion coefficient, and the crack generation ratio increase, and the glass is liable to be devitrified. Accordingly, the content of MgO is preferably 10% or less, 9% or less, 6% or less, or from 0.1 to 4%, particularly preferably from 1 to 3%.

CaO is a component that lowers the viscosity at high temperature to enhance the meltability, the formability, the strain point, and the Young's modulus. However, when the content of CaO is too large, the density, the thermal expansion coefficient, and the crack generation ratio increase, and the glass is liable to be devitrified. Further, it becomes difficult to achieve a large depth of layer. Accordingly, the content of CaO is preferably 10% or less, 6% or less, 5% or less, 3% or less, 1% or less, less than 1%, or 0.5% or less, particularly preferably 0.1% or less.

SrO is a component that lowers the viscosity at high temperature to enhance the meltability, the formability, the strain point, and the Young's modulus. However, when the content of SrO is too large, the density, the thermal expansion coefficient, end the crack generation ratio increase, and the glass is liable to be devitrified. Further, the ion exchange performance tends to lower. Accordingly, the content of SrO is preferably 10% or less, 8% or less, 5% or less, 3% or less, 1% or less, or 0.8% or less, particularly preferably 0.5% or less. Further, it is most preferred that the tempered glass substrate be substantially free of SrO. Herein, the “substantially free of SrO” refers to the case where the content of SrO is 0.2% or less in the glass composition.

BaO is a component that lowers the viscosity at high temperature to enhance the meltability, the formability, the strain point, and the Young's modulus. However, when the content of BaO is too large, the density, the thermal expansion coefficient, and the crack generation ratio increase, and the glass is liable to be devitrified. Further, the ion exchange performance tends to lower. In addition, the raw material compound for BaO is a substance of concern, and hence it is preferred to use BaO in as small an amount as possible from an environmental viewpoint. Accordingly, the content of BaO is preferably 3% or less, 2.5% or less, 2% or less, 1% or less, or 0.8% or less, particularly preferably 0.5% or less. Further, it is more preferred that the tempered glass substrate be substantially free of BaO. Herein, the “substantially free of BaO” refers to the case where the content of BaO is 0.1% or less in the glass composition.

When the content of MgO+CaO+SrO+BaO (the total content of MgO, CaO, SrO, and BaO) is too large, there ere tendencies that the density and the thermal expansion coefficient increase, the devitrification resistance lowers, and the ion exchange performance lowers. Accordingly, the content of MgO+CaO+SrO+BaO is preferably from 0 to 16%, from 0 to 10%, or from 0 to 6%, particularly preferably from 0 to 3%.

When a value obtained by dividing the content of MgO+CaO+SrO+BaO by the content of Li₂O+Na₂O+K₂O becomes large, the density tends to increase, and the devitrification resistance tends to lower. Accordingly, the mass ratio (MgO+CaO+SrO+BaO)/(Li₂O+Na₂O+K₂O) is preferably 0.5 or less, 0.4 or less, 0.3 or less, or 0.02 or less, particularly preferably 0.1 or less.

ZnO has an effect of increasing the compressive stress value. In addition, ZnO has effects of lowering the viscosity at high temperature and enhancing the Young's modulus. However, when the content of ZnO is too large, there are tendencies that the density and the thermal, expansion coefficient increase, and the devitrification resistance lowers. Accordingly, the content of ZnO is preferably from 0 to 15%, from 0 to 10%, from 0 to 2%, or from 0 to 0.5%, particularly preferably from 0 to 0.1%.

TiO₂ is a component that enhances the ion exchange performance. However, when the content of TiO₂ is too large, the glass is liable to be devitrified or colored. Accordingly, the content of TiO₂ is preferably from 0 to 10%, from 0 to 5%, or from 0 to 1%, particularly preferably from 0 to 0.5%. Further, it is more preferred that the tempered glass substrate be substantially free of TiO₂. Herein, the “substantially free of TiO₂” refers to the case where the content of TiO₂ is 0.1% or less in the glass composition.

ZrO₂ is a component that enhances the strain point, the Young's modulus, and the ion exchange performance, and is also a component that lowers the viscosity at high temperature. In addition, ZrO₂ has an effect of increasing a viscosity around the liquidus temperature. However, when the content of ZrO_{z} is too large, the devitrification resistance may extremely lower. Accordingly, the content of ZrO₂ is preferably from 0 to 10%, from 0 to 3%, from 0 to 7%, from 0 to 5%, from 0 to 3%, or from 0 to 1%, particularly preferably 0% or more and less than 0.1%.

P₂O₅ is a component that enhances the ion exchange performance, and in particular, is a component that increases the depth of layer. However, when the content of P₂O₅ too large, the glass is liable to manifest phase separation. Accordingly, the content of P₂O₅ is preferably 8% or less, 5% or less, 4% or less, or 3% or less, particularly preferably 2% or less. In addition, the content of P₂O₅ is too large, the water resistance is liable to lower. It should be noted that, when the film is formed on the main surface and the film has a sufficient protection function, a reduction in the water resistance does not need to be considered in some cases. In the case of introducing P₂O₅, the content of P₂O₅ is preferably 0.1% or more, or 0.5% or more, particularly preferably 1% or more.

It is preferred that the tempered glass substrate comprise as a fining agent one kind or two or more kinds selected from SO₃, Cl, CeO₂, Sb₂O₃, and SnO₂ in an amount of from 0 to 3%. As₂O₃ and F each also show a fining effect, but may exhibit an adverse influence on environments. Therefore, it is preferred that the use of As₂O₃ and F be reduced as much as possible, and it is more preferred that the tempered glass substrate be substantially free of As₂O₃ and F. In addition, Sb₂O₃ has low toxicity as compared to As₂O₃, but the use thereof is limited from the environmental standpoint in some cases, and it is preferred that the tempered glass substrate be substantially free of Sb₂O₃ in some cases. In addition, when the environmental standpoint, and the fining effect are taken into consideration, it is preferred that the tempered glass substrate comprise as the fining agent SnO₂ in an amount of from 0.01 to 3% (desirably from 0.05 to 1%). Herein, the “substantially free of As₂O₃” refers to the case where the content of As₂O₃ is 0.1% or less in the glass composition. The “substantially free of F” refers to the case where the content of F is 0.05% or less in the glass composition. The “substantially free of Sb_{Z}O₃” refers to the case where the content of Sb₂O₃ is 0.1% or less in the glass composition. On the other hand, Sb₂O₃ and SO₃ show a high effect, of suppressing a decrease in transmittance among the fining agents. Therefore, in an application requiring a high transmittance, the content of Sb₂O₃+SO₃ (total content of Sb₂O₃ and SO₃) is preferably from 0.001 to 5%.

A transition metal element having a coloring action, such as Co, Ni, or Cu, may lower the transmittance of the tempered glass substrate. In particular, in a display application, when the content of a transition, metal oxide is too large, the visibility of a display may be deteriorated. Accordingly, the content of the transition metal oxide is preferably 0.5% or less, or 0.1% or less, particularly preferably 0.05% or less.

A rare earth oxide such as Nb₂O₅ or La₂O₃ is a component that enhances the Young's modulus. However, the raw material cost thereof is high. In addition, when the rare earth oxide is introduced in a large amount, the devitrification resistance is liable to lower. Accordingly, the content, of the rare earth oxide is preferably 3% or less, 2% or less, or 1% or less, particularly preferably 0.5% or less. Further, it is most preferred that the tempered glass substrate be substantially free of the rare earth oxide. Herein, the “substantially free of the rare earth oxide” refers to the case where the content of the rare earth oxide is 0.1% or less in the glass composition.

Because PbO is a substance of concern, it is preferred that the tempered glass substrate be substantially free of PbO. Herein, the “substantially free of PbO” refers to the case where the content of PbO is 0.1% or less in the glass composition.

The suitable content range of each component may be appropriately selected and need as a preferred glass composition range. Of those, examples of more preferred glass composition ranges include;

(1) a glass composition comprising, in terms of mass %, 45 to 75% of SiO₂, 1 to 25% of Al₂O₃, 0 to 9% of Li₂O, 7 to 20% of Na_{Z}O, and 0 to 8% of K₂O, and being substantially free of As_{Z}O₃, F, and PbO;
(2) a glass composition, comprising, in terms of mass %, 45 to 75% of SiO₂, 3 to 25% of Al₂O₃, 0 to 3.5% of Li₂O, 7 to 20% of Na₂O, and 0 to 8% of K₂O, having a mass ratio (Al₂O₃+K₂O)/Na₂O of from 0.1 to 3, and being substantially free of As₂O₃, F, and PbO;
(3) a glass composition comprising, in terms of mass %, 45 to 70% of SiO₂, 10 to 22% of Al₂O₃, 0 to 3% of Li₂O, 7 to 20% of Na_{Z}O, and 0 to 5% of K₂O, having a mass ratio (Al₂O₃+K₂O)/Na₂O of from 0.5 to 2, and being substantially free of As₂O₃, F, and PbO;
(4) a glass composition, comprising, in terms of masse, 45 to 65% of SiO₂, 10 to 22% of Al₂O₃, 0 to 3% of Li₂O, 7 to 16% of Na₂O, 0 to 8% of K₂O, and 0 to 10% of MgO+CaO+SrO+BaO, having a mass ratio (Al₂O₃+K₂O)/Na₂O of from 0.3 to 1.8, and being substantially free of As₂O₃, F, and PbO;
(5) a glass composition comprising, in terms of mass %, 45 to 65% of SiO₂, 11 to 22% of Al₂O₃, 0 to 3% of Li₂O, 7 to 16% of Na₂O, 0 to 5% of K₂O, 0 to 3% of MgO, and 0 to 9% of MgO+CaO+SrO+BaO, having a mass ratio (Al₂O₃+K₂O)/Na₂O of from 1 to 1.5, and being substantially free of As₂O₃, F, and PbO;
(6) a glass composition comprising, in terms of mass %, 50 to 63% of SiO₂, 11 to 20% of Al₂O₃, 0 to 2% of Li₂O, 8 to 15.5% of Na₂O, 0 to 5% of K₂O, 0 to 3% of MgO, and 0 to 8% of MgO+CaO+SrO+BaO, having a mass ratio (Al₂O₃+K₂O/Na₂O of from 1 to 1.5, and being substantially free of As₂O₃, F, and PbO; and
(7) a glass composition comprising, in terms of mass %, 50 to 63% of SiO₂, 11 to 20% of Al₂C₃, 0 to 1% of Li₂O, 8 to 15% of Na₂O, 0.1 to 5% of K₂O, 0 to 2.5% of MgO, and 0 to 6% of MgO+CaO+SrO+BaO, having a mass ratio (Al₂O₃+K₂O)/Na₂O of from 1 to 1.5, and being substantially free of As₂O₃, F, and PbO.

The tempered glass substrate of the present invention preferably has the following glass characteristics.

The density is preferably 2.8 g/cm³ or less, 2.7 g/cm³ or less, 2.6 g/cm³ or less, 2.57 g/cm³ or less, 2.55 g/cm³ or less, 2.5 g/cm³ or less, or 2.45 g/cm³ or less, particularly preferably 2.4 g/cm³ or less. As the density becomes lower, the tempered glass substrate can achieve a lighter weight.

The strain point is preferably 500° C. or more, 510° C. or more, 520° C. or more, 530° C. or more, 540° C. or more, 550° C. or more, or 560° C. or more, particularly preferably 570° C. or more. As the strain point becomes higher, stress relaxation is less liable to occur during the ion exchange treatment, and thus the compressive stress value can be increased more easily. Herein, the “strain point” refers to a value measured based on a method of ASTM C336. It should be noted that, the strain point, tends to increase when the content of an alkaline earth metal oxide, Al₂O₃, ZrO₂, or P₂O₅ is increased or the content of an alkali metal oxide is reduced in the glass composition.

The temperature at a viscosity at high temperature of 10^{2.5} dPa·s is preferably 1,700° C. or less, 1,600° C. or less, 1,560° C. or less, 1,500° C. or less, 1,450° C. or less, or 1,420° C. or less, particularly preferably 1,400° C. or less. As the temperature at a viscosity at high temperature of 10^{2.5} dPa·s becomes lower, a burden on glass manufacturing equipment such as a melting furnace is reduced more, and the bubble quality of the glass substrate: can be enhanced more. That is, as the temperature at a viscosity at high temperature of 10^{2.5} dPa·s becomes lower, the manufacturing cost of the glass substrate is reduced more easily. Herein, the “temperature at a viscosity at high temperature of 10^{2.5} dPa·s” refers to a value measured by a platinum, sphere pull up method. It should be noted that the temperature at a viscosity at high temperature of 10^{2.5} dPa·s corresponds to the melting temperature of the glass, and as the temperature at a viscosity at high temperature of 10^{2.5} dPa·s becomes lower, the glass can be melted at a lower temperature.

The thermal expansion coefficient is preferably from 40 to 110×10⁻⁷/° C., from 70 to 105×10⁻⁷/° C., from 75 to 100×10⁻⁷/° C., or from 80 to 100×10⁻⁷/° C., particularly preferably from 30 to 90×10⁻⁷/° C. When the thermal expansion coefficient is controlled within the above-mentioned range, it becomes easy to match the thermal expansion coefficient with those of members made of a metal, an organic adhesive, and the like, and the members made of a metal, an organic adhesive, and the like are easily prevented from being peeled off. Herein, the “thermal expansion coefficient” refers to a value obtained through measurement of an average value in the temperature range of from 30 to 380° C. with a dilatometer.

The Young's modulus is preferably 61 GPa or more, 68 GPa or more, 70 GPa or mere, or 71 GPa or more, particularly preferably 73 GPa or more. As the Young's modulus becomes higher, the tempered glass substrate is less liable to be deflected, and in a device such a touch panel display, a liquid crystal element or the like in the device is less liable to be pressed when the display is pushed with a pen or the like. As a result, a display defect is less liable to be caused in the display. On the other hand, when the Young's modulus is too high, a stress generated through deformation of the tempered glass substrate pushed with a pen or the like becomes large, which may result in breakage. In. particular, in the case where the tempered glass substrate has a small thickness, an attention is preferably paid to this point. Accordingly, the Young's modulus is preferably 100 GPa or less, 95 GPa or less, 90 GPa or less, 85 GPa or less, or 80 GPa or less, particularly preferably 78 GPa or less.

The specific Young's modulus is preferably 27 GPa/(g/cm³) or more, 28 GPa/(g/cm³) or more, or 29 GPa/(g/cm³) or more, particularly preferably 30 GPa/(g/cm³) or more. As the specific Young's modulus becomes higher, the tempered glass substrate is less liable to be deflected by its own weight. As a result, when the tempered glass substrates are accommodated in a cassette and the like, the tempered glass substrates can be accommodated with a reduced clearance therebetween. Thus, the manufacturing efficiencies of the tempered glass substrate and a device are easily enhanced.

The liquidus temperature is preferably 1,200° C. or less, 1,100° C. or less, 1,050° C. or less, 1,000° C. or less, 930° C. or less, or 900° C. or less, particularly preferably 880° C. or less. As the liquidus temperature becomes lower, the glass is less liable to be devitrified during the formation of the glass substrate by an overflow down-draw method or the like. Herein, the “liquidus temperature” refers to a value obtained as follows: the glass is pulverised; then glass powder that passes through a standard 30-mesh sieve (sieve opening; 500 μm) and remains on a 50-mesh sieve (sieve opening; 300 μm) is placed in a platinum boat and kept for 24 hours in a gradient heating furnace; and a temperature at which a crystal is deposited is measured.

The liquidus viscosity is preferably 10^{4.0} dPa·s or more, 10^{4.3} dPa·s or more, 10^{4.5} dPa·s or more, 10^{5.0} dPa·s or more, 10^{5.5} dPa·s or more, 10^{5.7} dPa·s or more, or 10^{5.9} dPa·s or more, particularly preferably 10^{6.6} dPa·s or more. As the liquidus viscosity becomes higher, the glass is less liable to be de vitrified during the formation of the glass substrate by an overflow down-draw method or the like. Herein, the “liquidus viscosity” refers to a value obtained by measuring the viscosity of the glass at the liquidus temperature by a platinum sphere pull up method.

A method of manufacturing a tempered glass substrate of the present invention comprises: a step (1) of blending glass raw materials to obtain a glass batch; a step (2) of melting the glass batch, followed by forming obtained molten glass into a glass substrate having a thickness of 1.5 mm or less; a step (3) of forming a film on a main surface of the glass substrate; and a step (4) of subjecting the glass substrate comprising the film to ion exchange treatment to form compressive stress layers in the main surface and an end surface of the glass substrate, to thereby obtain a tempered glass substrate. In relation to the technical features of the method of manufacturing a tempered glass substrate of the present invention (the glass composition, the glass characteristics, and the like), the descriptions of the already-described matters are omitted for the sake of convenience.

In the method of manufacturing a tempered glass substrate of the present invention, a glass substrate having a thickness of 1.5 mm or less is preferably formed by an overflow down-draw method. The overflow down-draw method enables easy formation of a thin glass substrate. Herein, the “overflow down-draw method” refers to a method comprising causing molten glass to overflow from both sides of a heat-resistance trough-shaped structure, and subjecting the overflowing molten glasses to down-draw downward while the molten glasses are joined at the lower end of the trough-shaped structure, to thereby form a glass substrate. The structure and material of the trough-shaped structure are not particularly limited as long as desired dimensions and desired surface quality can be realised. In addition, a method of applying a force during the down-draw downward is not particularly limited. For example, there may foe employed: a method involving allowing a heat-resistance roll having a sufficiently large width to rotate while the roll is brought into contact with the glasses, to draw down the glasses; or a method involving bringing a plurality of pairs of heat-resistance rolls into contact with the glasses only in the vicinity of end edges thereof, to draw down the glasses. It should be noted that, when the liquidus temperature is 1,200 or less and the liquidus viscosity is 10^{4.0} dPa·s or more, a thin glass substrate can be formed by the overflow down-draw method.

It should be noted that, other than the overflow down-draw method, various forming methods such as a float method, a slot down method, a re-draw method, a roil out method, and a press method may be employed.

The method of manufacturing a tempered glass substrate of the present invention comprises the step of subjecting the glass substrate to ion exchange treatment to form compressive stress layers in the main surface and an end surface of the glass substrate, to thereby obtain a tempered glass substrate. The ion exchange treatment is a method involving introducing an alkali ion having a large ionic radius in the glass surface at a temperature equal to or less than the strain point of the glass substrate. The conditions of the ion exchange treatment are not particularly limited, and may be determined in consideration of the viscosity characteristics of the glass substrate, and the like. In particular, when a Ha component in the glass composition is ion exchanged with a K ion in a KNO₃ molten salt, the compressive stress layers can be efficiently formed. It should be noted that the ion exchange treatment has an advantage in that, even when the tempered glass substrate is cut after the ion exchange treatment, the tempered glass substrate does not easily break, unlike a physical tempering method such as an air cooling tempering method.

As particularly preferred conditions of the ion exchange treatment, the glass substrate is immersed in a KNO₃ molten salt at from 350 to 500° C. for from 2 to 24 hours. With this, the compressive stress layers can be efficiently formed in the glass substrate.

The method of manufacturing a tempered glass substrate of the present invention is preferably prevented from comprising, after the step of subjecting the glass substrate comprising the film to ion exchange treatment, a step of removing the film. With this, the film can be effectively utilized as a functional film such as a conductive film or an antireflection film. As a result, the manufacturing efficiency of the tempered glass substrate can be enhanced.

In contrast, the method of manufacturing a tempered glass substrate of the present invention may comprise, after the step of subjecting the glass substrate comprising the film to ion exchange treatment, the step of removing the film. An investigation made by the inventors of the present invention has revealed that the film causes a reduction in the in-plane strength of the main surface after the ion exchange treatment in some cases. In those cases, such situation can be appropriately avoided by separately conducting the step of removing the film after the ion exchange treatment. It should be noted, that the film may be fully removed in the step of removing the film, but even, when the film is partially removed, the above-mentioned effect can be exhibited.

The step of removing the film is preferably performed by etching. For example, in the case of a tempered glass substrate comprising a SiO₂ film, the SiO₂ film is etched preferably with a F-containing solution, particularly preferably with a HF solution. With this, the film can be appropriately removed while the in-plane strength of the main surface is increased.

When the film is etched, the end surf ace may be protected with a resin or the like so that the end surface is prevented from being etched. With this, the DT/DH value is easily controlled in the predetermined range. On the other hand, when the film is etched, the end surface may be concurrently etched. With this, a crack source present on the end surface is reduced, and thus the strength of the end surface can be increased.

### EXAMPLES

Hereinafter, the present invention is described by way of Examples. It should be noted that Examples of the present invention are merely illustrative. The present invention is by no means limited to Examples described below.

Tables 1 and 2 show material, examples of tempered glass (sample Nos. 1 to 20).

TABLE 1

| | | No. 1 | No. 2 | No. 3 | No. 4 | No. 5 | No. 6 | No. 7 | No. 8 | No. 9 | No. 10 |
|---|---|---|---|---|---|---|---|---|---|---|---|
| Glass | SiO₂ | 57.7 | 59.1 | 57.1 | 55.0 | 54.9 | 58.5 | 60.0 | 60.3 | 59.4 | 60.0 |
| composition | Al₂O₃ | 20.0 | 17.9 | 19.8 | 19.9 | 19.9 | 20.4 | 19.0 | 18.9 | 18.7 | 18.0 |
| (mass %) | B₂O₃ | 0.5 | 0.5 | 0.5 | 0.5 | 0.5 | 0.5 | 4.4 | 1.3 | 0.5 | 4.4 |
| | Li₂O | — | — | — | — | — | — | — | — | — | — |
| | Na₂O | 13.3 | 12.1 | 12.1 | 12.1 | 15.2 | 15.1 | 10.1 | 15.1 | 15.0 | 14.2 |
| | K₂O | 4.0 | 5.0 | 5.0 | 5.0 | 2.1 | 2.1 | 3.1 | — | 2.0 | — |
| | MgO | 3.0 | 3.0 | 3.0 | 3.0 | 3.0 | 1.0 | 2.9 | 2.9 | 2.9 | 3.0 |
| | CaO | 1.0 | 1.0 | 1.0 | 1.0 | 1.0 | 2.0 | — | — | 1.0 | — |
| | ZrO₂ | — | — | — | — | — | — | — | — | — | — |
| | P₂O₅ | — | 1.0 | 1.0 | 3.0 | 3.0 | — | — | 1.0 | — | — |
| | SnO₂ | 0.5 | 0.5 | 0.5 | 0.5 | 0.5 | 0.5 | 0.5 | 0.5 | 0.5 | 0.5 |

| | | | | | | | | | | |
|---|---|---|---|---|---|---|---|---|---|---|
| Density [g/cm³] | 2.47 | 2.46 | 2.47 | 2.47 | 2.48 | 2.47 | 2.41 | 2.44 | 2.47 | 2.43 |
| Ps [° C.] | 585 | 574 | 593 | 605 | 593 | 574 | 581 | 587 | 571 | 560 |
| Ta [° C.] | 635 | 624 | 643 | 658 | 643 | 621 | 634 | 637 | 619 | 607 |
| Ts [° C.] | 875 | 866 | 888 | 916 | 889 | 854 | 892 | 880 | 853 | 836 |
| 10^{4.0} dPa · s [° C.] | 1,255 | 1,256 | 1,271 | 1,268 | 1,230 | 1,243 | 1,297 | 1,267 | 1,230 | 1,227 |
| 10^{3.0} dPa · s [° C.] | 1,450 | 1,456 | 1,465 | 1,460 | 1,419 | 1,450 | 1,497 | 1,465 | 1,428 | 1,431 |
| 10^{2.5} dPa · s [° C.] | 1,570 | 1,582 | 1,587 | 1,579 | 1,538 | 1,578 | 1,624 | 1,590 | 1,553 | 1,557 |
| α [×10⁻⁷/° C.] | 94 | 94 | 95 | 96 | 96 | 93 | 78 | 84 | 93 | 92 |
| (30 to 380° C.) | | | | | | | | | | |
| Young's modulus [GPa] | — | 72 | 72 | 73 | 72 | 72 | 69 | 70 | 72 | 69 |
| Specific Young's modulus | — | 29.2 | 29.4 | 29.3 | 29.0 | 29.3 | 28.8 | 28.6 | 29.3 | 28.5 |
| [GPa/(g/cm³)] | | | | | | | | | | |
| TL [° C.] | 1,068 | 1,003 | 1,076 | 1,122 | 1,089 | 991 | — | 1,039 | 1,004 | 1,053 |
| log η at TL [dPa · s] | 5.4 | 6.0 | 5.4 | 5.1 | 5.1 | 5.9 | — | 5.7 | 5.8 | 5.2 |
| CS [MPa] | 1,098 | 955 | 1,047 | 1,016 | 1,124 | 1,037 | 930 | 1,048 | 1,005 | 977 |
| DOL [μm] | 53 | 58 | 59 | 70 | 56 | 45 | 45 | 43 | 46 | 34 |

TABLE 2

| | | No. 11 | No. 12 | No. 13 | No. 14 | No. 15 | No. 16 | No. 17 | No. 18 | No. 19 | No. 20 |
|---|---|---|---|---|---|---|---|---|---|---|---|
| Glass | SiO₂ | 58.7 | 66.6 | 60.9 | 58.8 | 60.9 | 61.1 | 61.6 | 58.0 | 59.0 | 60.0 |
| composition | Al₂O₃ | 19.4 | 13.0 | 19.9 | 19.9 | 19.9 | 18.9 | 17.9 | 23.0 | 23.0 | 21.0 |
| (mass %) | B₂O₃ | 0.5 | 4.0 | 3.1 | 5.1 | 2.0 | 2.4 | 0.4 | — | 1.0 | 1.0 |
| | Li₂O | — | — | — | — | — | — | — | — | — | — |
| | Na₂O | 14.9 | 10.0 | 14.6 | 14.7 | 14.7 | 13.6 | 14.6 | 16.5 | 14.5 | 15.5 |
| | K₂O | 2.1 | 3.0 | — | — | — | 1.5 | 2.0 | — | — | — |
| | MgO | 3.0 | 2.9 | 1.0 | 1.0 | 2.0 | 2.0 | 3.0 | 2.0 | 2.0 | 2.0 |
| | CaO | 1.0 | — | — | — | — | — | — | — | — | — |
| | ZrO₂ | — | — | — | — | — | — | — | — | — | — |
| | P₂O₅ | — | — | — | — | — | — | — | — | — | — |
| | SnO₂ | 0.5 | 0.5 | 0.5 | 0.5 | 0.5 | 0.5 | 0.5 | 0.5 | 0.5 | 0.5 |

| | | | | | | | | | | |
|---|---|---|---|---|---|---|---|---|---|---|
| Density [g/cm³] | 2.47 | 2.40 | 2.42 | 2.42 | 2.43 | 2.43 | 2.45 | 2.46 | 2.44 | 2.44 |
| Ps [° C.] | 564 | 554 | 574 | 556 | 590 | 571 | 579 | 636 | 631 | 604 |
| Ta [° C.] | 623 | 601 | 624 | 603 | 642 | 621 | 629 | 690 | 688 | 657 |
| Ts [° C.] | 856 | 843 | 877 | 836 | 898 | 874 | 875 | 939 | 954 | 910 |
| 10^{4.0} dPa · s [° C.] | 1,225 | 1,261 | 1,293 | 1,255 | 1,299 | 1,284 | 1,261 | 1,318 | 1,343 | 1,307 |
| 10^{3.0} dPa · s [° C.] | 1,420 | 1,486 | 1,504 | 1,472 | 1,503 | 1,495 | 1,463 | 1,510 | 1,533 | 1,507 |
| 10^{2.5} dPa · s [° C.] | 1,542 | 1,622 | 1,642 | 1,606 | 1,628 | 1,623 | 1,589 | 1,630 | 1,653 | 1,630 |
| α [×10⁻⁷/° C.] | 94 | 78 | 83 | 83 | 83 | 85 | 92 | 90 | 82 | 86 |
| (30 to 380° C.) | | | | | | | | | | |
| Young's modulus [GPa] | 72 | 70 | — | — | 69 | 70 | 71 | 71 | 71 | 70 |
| Specific Young's modulus | 29.2 | 29.2 | — | — | 28.5 | 28.9 | 29.0 | 28.7 | 28.9 | 28.7 |
| [GPa/(g/cm³)] | | | | | | | | | | |
| TL [° C.] | 1,053 | 971 | 1,027 | 1,003 | 1,036 | 940 | 1,012 | — | — | 1,029 |
| log η at TL [dPa · s] | 5.3 | 6.1 | 5.9 | 5.7 | 6.0 | 6.7 | 5.9 | — | — | 6.2 |
| CS [MPa] | 1,046 | 728 | 987 | 943 | 1,074 | 995 | 960 | 1,310 | 1,321 | 1,226 |
| DOL [μm] | 45 | 40 | 44 | 39 | 44 | 42 | 48 | 44 | 39 | 37 |

The samples were each produced as described below. First, glass raw materials were blended so as to give a glass composition shown in Table 1 or 2, to produce a glass batch. After that, the glass batch was placed in a platinum pot and then melted at 1,600° C. for 8 hours, to obtain molten glass. Next, the molten glass was poured on a carbon sheet and formed into a glass substrate. The obtained glass substrate was evaluated for various characteristics.

The density is a value obtained through measurement by a well-known Archimedes method.

The strain point Ps and the annealing point Ta are values obtained through measurement based on a method of ASTM C336.

The softening point Ts is a value obtained through measurement based on a method of ASTM C338.

The temperatures at viscosities at high temperature of 10^{4.0} dPa·s, 10^{3.0} dPa·s, and 10^{2.5} dPa·s were measured by a well-known platinum sphere pull up method.

The thermal expansion coefficient o is a value obtained through measurement of an average thermal expansion coefficient in the range of from 30 to 380° C. using a dilatometer.

The liquidus temperature TL is a value obtained as follows: the glass substrate is pulverised; then glass powder that passes through a standard 30-mesh sieve (sieve opening; 500 μm) and remains on a 50-mesh sieve (sieve opening: 300 μm) is placed in a platinum boat and kept for 24 hours in a gradient heating furnace; and a temperature at which a crystal is deposited is measured. The liquidus viscosity loop at TL refers to a value obtained through measurement of the viscosity of the glass at the liquidus temperature TL by a platinum sphere pull up method.

The Young's modulus is a value obtained through measurement by a resonance method. In addition, the specific Young's modulus is a value obtained by dividing the Young's modulus by the density.

As apparent from Tables 1 and 2, each of the samples Nos. 1 to 20 had a density of 2.48 g/cm³ or less, a Young's modulus of 69 GPa or more, and a thermal expansion coefficient of from 78 to 96×10⁻⁷/° C. Further, each of the samples Nos. 1 to 20 had a liquidus viscosity of 10^{5.1} dPa·s or more, and a temperature at a viscosity at high temperature of 10^{2.5} dPa·s of 1,653° C. or less.

It should be noted that the glass compositions of an untempered glass substrate and a tempered glass substrate are microscopically different from each other at their surface layers, but substantially have no difference as a whole. Accordingly, the characteristics such as the density, the viscosity, and the Young's modulus are not substantially different between the untempered glass substrate and the tempered glass substrate,

Further, the main surfaces of the samples were each subjected to optical polishing, and then subjected to ion exchange treatment. The ion exchange treatment was performed as follows; the samples Nos. 1 to 17 were each immersed in a KNO₃ molten salt at 430° C. for 6 hours; and the samples Nos. 18 to 20 were each immersed in a KNO₃ molten salt, at 430° C. for 4 hours. Next, the surfaces of the samples after the ion exchange treatment were each washed, and then the compressive stress value CS and depth of layer DOL of a compressive stress layer were calculated on the basis of observation of the number of interference fringes and each interval between the interference fringes with a surface stress meter (FSM-6000 manufactured by Toshiba Corporation). It should be noted that, in the measurement, the refractive index and the optical elastic constant were set to 1.50 and 30[(nm/cm)/MPa], respectively.

As apparent from Tables 1 and 2, each of the samples Nos. 1 to 20 had a compressive stress value CS of 728 MPa or more, and a depth of layer DOL of 34 μm or more. In addition, the internal tensile stress value was calculated to be 88 MPa on the basis of the relational equation described in paragraph [0007].

In the above-mentioned experiment, the molten glass was poured out and formed into a glass substrate, and then subjected to optical polishing before the ion exchange treatment for the sake of convenience. However, from the viewpoint of the manufacturing efficiency, the glass substrate formed by the overflow down-draw method or the like is desirably subjected to the ion exchange treatment in an unpolished state in the manufacturing of the tempered glass substrate on an industrial scale.

Next, the materials of the sample No. 17 were used to form a glass substrate (thickness: 0.55 mm) by the over flow down-draw method. After that, SiO₂ films were formed on ail the main surfaces of the glass substrate (front surface and back surface) by a sputtering method. The pressure during the film formation was set to 0.3 Pa or 0.1 Pa. Thus, films each having a thickness of from 50 to 500 nm were formed. Further, the glass substrate comprising the films was subjected to ion exchange treatment (immersed in a KNO₃ molten salt at 430° C. for 6 hours). Thus, each of samples b to i was produced. It should be noted that the sample a is the one subjected to the ion exchange treatment without forming the films. Finally, the obtained tempered glass substrates were each placed on a surface plate, and a diamond stylus (27.4 g) was dropped thereon from a height of 50 mm. Then, the number of broken pieces after breakage was evaluated. The results are shown in Table 3.

TABLE 3

| | | Sputtering | | | | |
|---|---|---|---|---|---|---|
| | | pressure | | | | Number of |
| | Film | during film | | | | broken |
| | thickness | formation | CS | DOL | CT | pieces |
| | (nm) | (Pa) | (MPa) | (μm) | (MPa) | (piece) |
| a | 0 | — | 879 | 46 | 88 | 101 |
| b | 50 | 0.3 Pa | 891 | 41 | 78 | 49 |
| c | 100 | 0.3 Pa | 997 | 27 | 53 | 16 |
| d | 300 | 0.3 Pa | — | — | — | 3 |
| e | 500 | 0.3 Pa | — | — | — | 3 |
| f | 50 | 0.1 Pa | 888 | 41 | 77 | 39 |
| g | 100 | 0.1 Pa | 961 | 25 | 48 | 18 |
| h | 300 | 0.1 Pa | — | — | — | 3 |
| i | 500 | 0.1 Pa | — | — | — | 2 |

The sample a was found to have a compressive stress value CS of 879 MPa and a depth of layer DOL of 46 μm in the main surface. Accordingly, in each of the samples a to i, the compressive stress value CS and depth of layer DOL in the end surface are considered to be about 879 MPa and about 46 μm, respectively.

As apparent from Table 3, in each or the samples b to i, the depth of layer DOL in the end surface was larger than the depth of layer DOL in the main surface, and hence the internal tensile stress value CT was smaller than that of the sample a. As a result, the number of broken, pieces after the drop test was lower. It should be noted that, although each of the samples d, e, h, and i was not measured for the compressive stress value CS and the depth of layer DOL, it is estimated that the depth of layer DOL in the end surface was larger than the depth of layer DOL in the main surface and the internal tensile stress value CT was lower, because the number of broken pieces was lower.

In the experiment shown in Table 3, the materials of the sample No. 17 were used for the sake of convenience, but it is considered that the same tendency is shown also: in the case of using the materials of the samples Nos. 1 to 16 and 18 to 20.

The step of removing the SiO₂ films was not conducted in the above-mentioned experiment, but from the viewpoint of increasing both the in-plane strength of the main surface and the strength of the end surface, it is preferred to immerse the tempered glass substrate comprising the SiO₂ films in a HF aqueous solution, so as to etch the SiO₂ films and concurrently reduce a crack source present on the end surface.

### INDUSTRIAL APPLICABILITY

The tempered glass substrate of the present invention is suitable for a cover glass for a cellular phone, a digital camera, a PDA, or the like, or a substrate for a touch panel display or the like. Further, the tempered glass substrate of the present invention is expected to find use in applications requiring high strength, for example, a window glass sheet, a substrate for a magnetic disk, a substrate for a flat panel display, a cover glass for a solar cell, a cover glass for a solid image pick-up element, and tableware, in addition to the above-mentioned applications.

1. A tempered glass substrate having a compressive stress layer,
the tempered glass substrate having a thickness of 1.5 mm or less, and a depth of layer in an end surface larger than a depth of layer in a main surface.

2. The tempered glass substrate according to claim 1, wherein the main surface is unpolished.

3. The tempered glass substrate according to claim 1, wherein the main surface is prevented from being etched.

4. The tempered glass substrate according to claim 1, wherein the tempered glass substrate comprises a film on the main surface.

5. The tempered glass substrate according to claim 4, wherein the film has a thickness of from 5 to 1,000 nm.

6. The tempered glass substrate according to claim 4, wherein the tempered glass substrate contains as a component of the film any one of SiO₂, Nb₂O₅, TiO₂, and ITO.

7. The tempered glass substrate according to claim 1, wherein the tempered glass substrate has an internal tensile stress value of 200 MPa or less.

8. The tempered glass substrate according to claim 1, wherein the tempered glass substrate comprises as a glass composition, in terms of mass %, 45 to 75% of SiO₂, 1 to 30% of Al₂O₃, 0 to 20% of Na₂O, and 0 to 20% of K₂O.

9. The tempered glass substrate according to claim 1, wherein the tempered glass substrate has a compressive stress value and depth of layer in the main surface of 50 MPa or more and 100 μm or less, respectively, and a compressive stress value and depth of layer in the end surface of 300 MPa or more and 10 μm or more, respectively.

10. The tempered glass substrate according to claim 1, wherein the tempered glass substrate has a density of 2.6 g/cm³ or less.

11. The tempered glass substrate according to claim 1, wherein the tempered glass substrate has a Young's modulus of 67 GPa or more.

12. The tempered glass substrate according to claim 1, wherein the tempered glass substrate is used for a display.

13. The tempered glass substrate according to claim 1, wherein the tempered glass substrate is used for a touch panel display.

14. A method of manufacturing a tempered glass substrate, the method comprising:
a step (1) of blending glass raw materials to obtain a glass batch;
a step (2) of melting the glass batch, followed by forming the resultant molten glass into a glass substrate having a thickness of 1.5 mm or less;
a step (3) of forming a film on a main surface of the glass substrate; and
a step (4) of subjecting the glass substrate comprising the film to ion exchange treatment to form compressive stress layers in the main surface and an end surface of the glass substrate, to thereby obtain a tempered glass substrate.
